(19) United States
(12) Patent Application Publication
(10) Pub. No.: US 2021/0071856 A1
(43) Pub. Date: Mar. 11, 2021

(54) POLE LIGHT

(71) Applicant: PRO PAINT GEAR INC., Brighton (CA)

(72) Inventor: Jack A. MITCHELL, Brighton (CA)

(21) Appl. No.: 16/771,808

(22) PCT Filed: Dec. 11, 2018
(86) PCT No.: PCT/CA2018/051576

§ 371 Date: Jun. 11, 2020

Related U.S. Application Data
(60) Provisional application No. 62/597,091, filed on Dec. 11, 2017.

(51) Int. Cl. F21V 23/04; F21V 15/01

(52) U.S. Cl. CPC F21V 23/0414; F21V 21/0885; F21V 15/01

(57) ABSTRACT

There is disclosed a pole handle mountable flashlight which includes a flashlight housing having two housing sections hingedly connected together, an inner wall of each of the two housing sections being of circular cross section to engage with a tubular shaped pole handle. A closure mechanism is affixed to one of the housing sections and the other housing section is configured to be locked to the closure mechanism when the flashlight is mounted on a pole handle. Each housing section includes a distal end having lights mounted therein so that when assembled on a pole handle the distal end faces toward the area that the tool, attached to the pole handle, is being worked, or example shovels, painting poles and the like. Batteries are mounted in one or both housing sections which are connected to a flashlight circuit board mounted in one or both housing sections. The flashlight circuit board is connected to the lights mounted in the respective housing sections. An on-off switch mounted on one of the outer surfaces of one of the housing sections connected to the flashlight circuit board in each housing section.

### FIELD

The present disclosure relates to an LED light that has the specific intent of being fastened to an extension pole or handle of a tool to illuminate the work area. The light when not fastened to the handle or pole may be used as an ordinary flashlight that has magnets present on the exterior for mounting to a steel surface.

### BACKGROUND

Existing flashlights, even though they may come in many different shapes or sizes, do not have the ability to fasten around an extension pole or handle to provide light that illuminates 360 degrees around the surface in which one is working. This is problematic when working in dark locations when the worker needs to keep both hands on the tool or extension pole instead of being able to hold a flashlight with one hand and work the tool with the other.

It would be very advantageous to provide a flashlight that can be integrated with any type of tool having a pole for a handle.

### SUMMARY

The present disclosure provides an LED flashlight configured to be integrated with pole handle of a tool, such as but not limited to shovels, brooms, paint brush, paint roller frame and pole assemblies etc.

There is disclosed a pole handle mountable flashlight which includes a flashlight housing including two housing sections hingedly connected together, a passageway through said flashlight housing being formed by an inner wall of each of the two housing sections being of circular cross section to engage with a tubular shaped pole handle, a closure mechanism affixed to one of said housing sections and the other housing section being configured to be locked to said closure mechanism;

each housing section having a distal end having lights mounted therein so that when assembled on a pole handle the distal end faces toward the area tool, attached to the pole handle, is being worked, a power source mounted in at least one housing section being connected to a flashlight circuit board mounted in each housing section, said flashlight circuit board mounted in at least one housing section being connected to the lights mounted in the respective housing sections; and an on-off switch mounted on one of the outer surfaces of one of the housing sections connected to the flashlight circuit board in each housing section.

The housing sections may both have a hemispherical shape so that when affixed to a pole handle the flashlight has a cylindrical shape.

The housing sections may be hingedly connected together by a living hinge.

The lights may be light emitting diodes (LED), and in this case the circuit board is an LED circuit board.

The closure mechanism may be a snap shut closure mechanism.

The flashlight may include foam friction pads mounted in each housing section so that when the two housing sections are closed around the pole handle friction is produced between the pole handle and flashlight to prevent rotation of the flashlight with respect to handle, and to accommodate the flashlight being fastened to different diameter pole handles.

The flashlight may include over molded friction ribs mounted in each housing section that act as a one way tube trap around the pole handle so the flashlight cannot slide up and down the handle.

The flashlight may include magnets affixed to an outer surface of one or both of said housing sections.

The flashlight may include the passageway through the flashlight housing being off center of a longitudinal axis of the housing so that one of the housing sections is thicker than the other housing section in which the power supply is located.

The power source may be one or more batteries.

A further understanding of the functional and advantageous aspects of the disclosure can be realized by reference to the following detailed description and drawings.

### BRIEF DESCRIPTION OF THE DRAWINGS

Embodiments will now be described, by way of example only, with reference to the drawings, in which:

FIG. 1 is a perspective view of a shovel having the light produced in accordance with the present disclosure affixed to the shovel handle.

FIG. 2 is an elevation front view of the shovel and light of FIG. 1.

FIG. 3 is an elevation side view of the shovel and light of FIG. 1.

FIG. 4 is a bottom view of the shovel and light looking from the bottom of the shovel.

FIG. 5 shows a sectional view of shovel and light of FIG. 2 along the line A-A.

FIG. 6 is a perspective view of the combination shovel and light similar to FIG. 1 but showing the light in the open unassembled position on the shovel handle.

FIG. 7 is a front view of the shovel and light combination similar to FIG. 2 but with the light open unassembled position on the shovel handle.

FIG. 8 shows a sectional view of shovel and light combination of FIG. 7 along the line A-A with the light in the open position and looking at the end of the light with the light emitting diodes (LED).

FIG. 9 is a top view of just the LED flashlight (not affixed to the shovel handle) in the open position.

FIG. 10 is a front elevational view of the LED flashlight in the open position.

FIG. 11 is a bottom view of the LED flashlight in the open position.

FIG. 12 is a perspective view of the LED flashlight in the open position.

FIG. 13 is front elevation view of the LED flashlight in the open position similar to FIG. 10 but rotated 90 degrees on its side.

FIG. 14 is a cross sectional view taken along line B-B of FIG. 13.

FIG. 15 is a detailed view a portion of the LED light in circle A of FIG. 14.

FIG. 16 is a front elevation view of the LED light in the open position showing the outer surface of the two housing sections.

FIG. 17 is a side elevation view of the LED light in the open position.

FIG. 18 is a perspective view of a handle with a handle mounted light in the open position showing non-slip ribs spaced along the interior of the light housing to prevent the light from sliding along the handle.

FIG. 19 is a closed view of the light unit on the handle or extension pole which is suitable to receive any number of devices on the threaded portion at the end of the pole such as paint roller frames, brooms to give a few non-limiting examples.

FIG. 20 is a rear view of an embodiment of a pole mounted lighting unit incorporating a speaker.

### DETAILED DESCRIPTION

Various embodiments and aspects of the disclosure will be described with reference to details discussed below. The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosure.

As used herein, the terms, “comprises” and “comprising” are to be construed as being inclusive and open ended, and not exclusive. Specifically, when used in the specification and claims, the terms, “comprises” and “comprising” and variations thereof mean the specified features, steps or components are included. These terms are not to be interpreted to exclude the presence of other features, steps or components.

As used herein, the term “exemplary” means “serving as an example, instance, or illustration,” and should not be construed as preferred or advantageous over other configurations disclosed herein.

As used herein, the terms “about” and “approximately”, when used in conjunction with ranges of dimensions of particles, compositions of mixtures or other physical properties or characteristics, are meant to cover slight variations that may exist in the upper and lower limits of the ranges of dimensions so as to not exclude embodiments where on average most of the dimensions are satisfied but where statistically dimensions may exist outside this region. It is not the intention to exclude embodiments such as these from the present disclosure.

The present disclosure provides an LED flashlight configured to be integrated with pole handle of a tool, such as but not limited to shovels, brooms, paint brush mounted at the end of a pole handle, paint roller frame and pole assemblies to mention a few.

In an embodiment disclosed herein a pole handle mountable flashlight includes a flashlight housing having two housing sections hingedly connected together, an inner wall of each of the two housing sections being of circular cross section to engage with a tubular shaped pole handle. A closure mechanism is affixed to one of the housing sections and the other housing section is configured to be locked to the closure mechanism when the flashlight is mounted on a pole handle. Each housing section includes a distal end having lights mounted therein so that when assembled on a pole handle the distal end faces toward the area that the tool, attached to the pole handle, is being worked, or example shovels, painting poles and the like. A power source mounted in at least one of the housing sections are connected to a flashlight circuit board mounted in at least one housing section. In an embodiment the flashlight circuit board is mounted in each housing section and is connected to the lights mounted in the respective housing sections. An on-off switch mounted on one of the outer surfaces of one of the housing sections connected to the flashlight circuit board in each housing section.

In an embodiment the housing sections both have a hemispherical shape so that when affixed to a pole handle the flashlight has a cylindrical shape.

In an embodiment the housing sections are hingedly connected together by a living hinge.

In an embodiment the lights are light emitting diodes (LED), and in this case the circuit board is an LED circuit board.

In an embodiment the closure mechanism is a snap shut closure mechanism.

In an embodiment the flashlight includes foam friction pads mounted in each housing section so that when the two housing sections are closed around the pole handle friction is produced between the pole handle and flashlight to prevent rotation of the flashlight with respect to handle, and to accommodate the flashlight being fastened to different diameter pole handles.

In an embodiment the flashlight includes over molded friction ribs mounted in each housing section that act as a one way tube trap around the pole handle so the flashlight cannot slide up and down the handle.

In an embodiment the flashlight includes magnets affixed to an outer surface of one or both of said housing sections.

In an embodiment the passageway through the flashlight housing is off center of a longitudinal axis of the housing so that one of the housing sections is thicker than the other housing section in which the power supply is located.

In an embodiment the power source is one or more batteries.

### PARTS LIST

10 Shovel
12 Flashlight
13 Hand Grip
14 On Off Button
15 Shovel Pole Handle
16 LED
17 Blade cutting Edge
18 Maximum Tube Diameter 1.25 inches
20 Minimum Tube Diameter 1 inch
22 AAA Battery
24 Circuit Board Retainer
26 Foam Friction Pad held in position with double sided tape
28 Over molded friction ribs that act as a one way tube trap
30 Magnet
32 LED Circuit board
34 On Off Switch support and LED circuit board Screw Holder
36 On Off Switch support
38 Living Hinge
40 Snap shut closure
60 Housing Section
62 Housing section

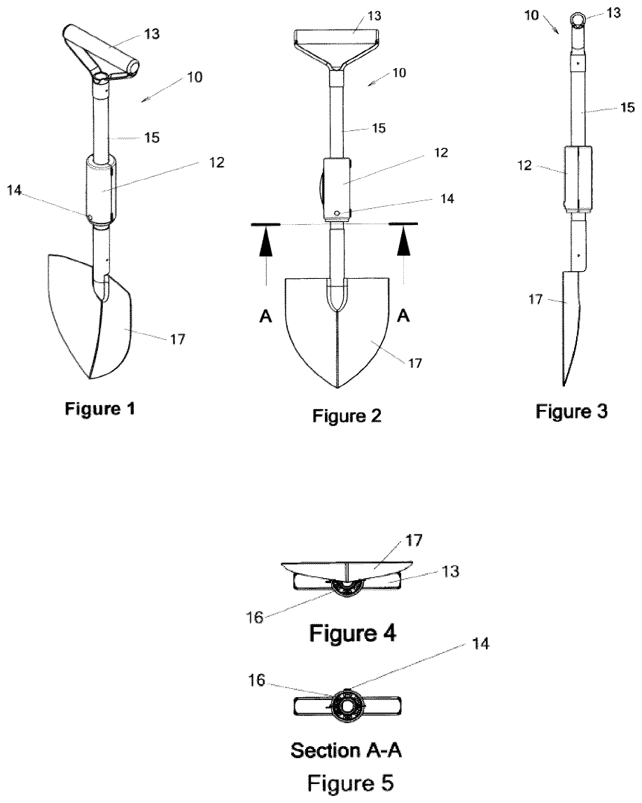

FIG. 1 is a perspective view of a shovel 10 having an elongate pole shaped shovel handle 15 having a pole handle 15 with a handgrip 13 at one end of the pole handle and a blade, cutting edge 17 at the other end with a flashlight 12 affixed to the shovel pole handle 15. FIG. 2 is an elevation front view of the combined shovel 10 and flashlight 12 of FIG. 1. FIG. 3 is an elevation side view of the combined shovel 10 and flashlight 12 of FIG. 1. FIG. 4 is a bottom view of the shovel 10 and flashlight 12 looking along the cutting edge and blade at the bottom of the shovel 10. FIG. 5 shows a sectional view of shovel and light of FIG. 2 along the line A-A where the LEDs 16 can be seen extending peripherally around the end of the flashlight 12 and on-off button 14 can be seen.

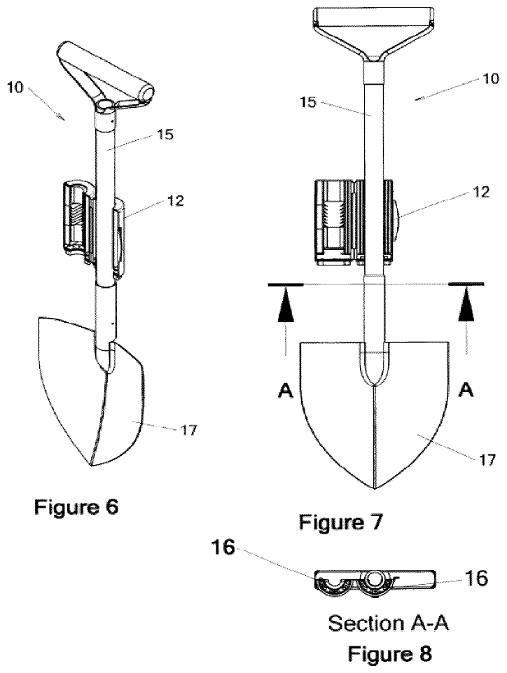

FIG. 6 is a perspective view of the combination shovel and light similar to FIG. 1 but showing the flashlight 12 in the open unassembled position on the shovel handle 15. FIG. 7 is a front view of the shovel and light combination similar to FIG. 2 but with the flashlight 12 open unassembled position on the shovel handle 15. FIG. 8 shows a sectional view of shovel and light combination of FIG. 7 along the line A-A with the light in the open position and looking at the end of the light with the light emitting diodes (LED).

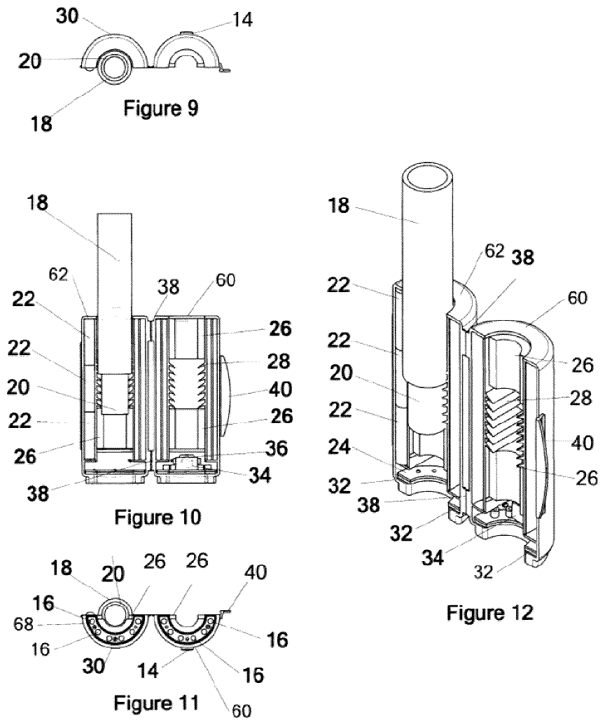

The LED flashlight 12 is configured to be affixed to different diameter sized pole handles. For example, FIGS. 10 and 12 show a pole handle 18 which is a standard sized pole handle of outer diameter 1.25 inches, while FIG. 9 shows a pole handle 20 which has a standard tube diameter of 1 inch on the interior of pole handle 20.

FIG. 10 is a front elevational view of the LED flashlight 12 in the open position. LED flashlight 12 includes two cylindrical housing sections 60 and 62 connected through a living hinge 38 so flashlight 12 can be easily opened and closed around pole handle 15. A snap shut closure 40 is integrally formed with housing section 60 and engages with housing section 62 when flashlight 12 is assembled around pole handle 15. Housing section 62 has inner and outer walls spaced from each other forming three chambers used to hold batteries 22. Foam friction pads 26 are held by double sided tape is located in housing sections 60 and 62 and produces friction between the pole handle 15 and LED flashlight 12 to prevent rotation of the LED flashlight 12 with respect to handle 15 when affixed to the handle 15. The foam pads 26 also allows the flashlight 12 to be fastened to different size poles or handles such as handles 18 and 20 discussed above.

Over molded friction ribs 28 are mounted in housing sections 60 and 62 so that when these housing sections are closed the friction ribs 28 act as a one way tube trap around the pole handle so LED flashlight 12 cannot slide up and down the handle 15.

Housing section 60 on which housing switch 14 is located includes an on-off switch support and LED circuit board screw holder 34 mounted on the interior of section 60 along with an on-off switch support 36.

FIG. 11 is a bottom view of the LED flashlight 12 in the open position showing the LEDs 16 at the end of the housing sections 60 and 62. The snap shut closure 40 located on housing section 60 can be seen in more detail and snaps over a lip 68 on housing section 62 when the flashlight 12 is closed around handle 15. It will be appreciated that any known closure mechanism may be used and is not limited to snap shut closure 40.

FIG. 12 is a perspective view of the LED flashlight 12 in the open position showing the LED circuit boards 32 mounted in both housing sections 60 and 62 located below a LED circuit board retainer 24.

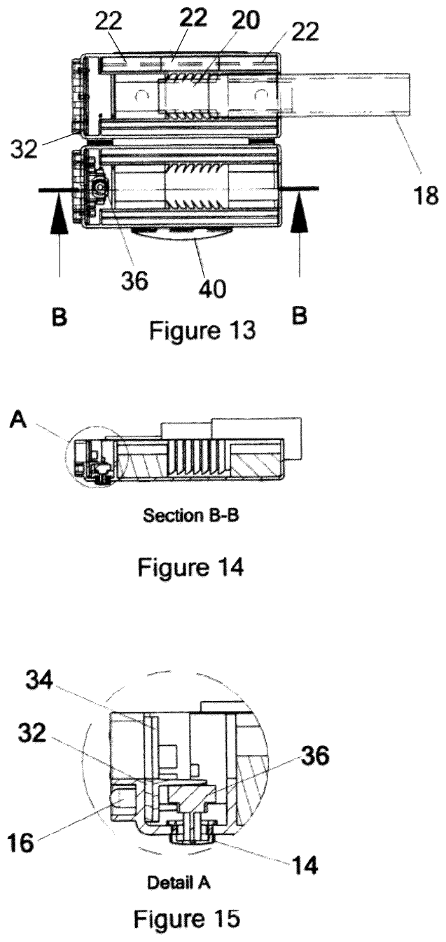

FIG. 13 is front elevation view of the LED flashlight in the open position similar to FIG. 10 but rotated 90 degrees on its side.

FIG. 14 is a cross sectional view taken along line B-B of FIG. 13 and FIG. 15 is a detailed view a portion of the LED light in circle A of FIG. 14 showing the relative positioning of the LED 16, the LED circuit board 32, the on-off switch 14, and on-off switch support and LED circuit board screw holder 34 and the on-off switch support 36.

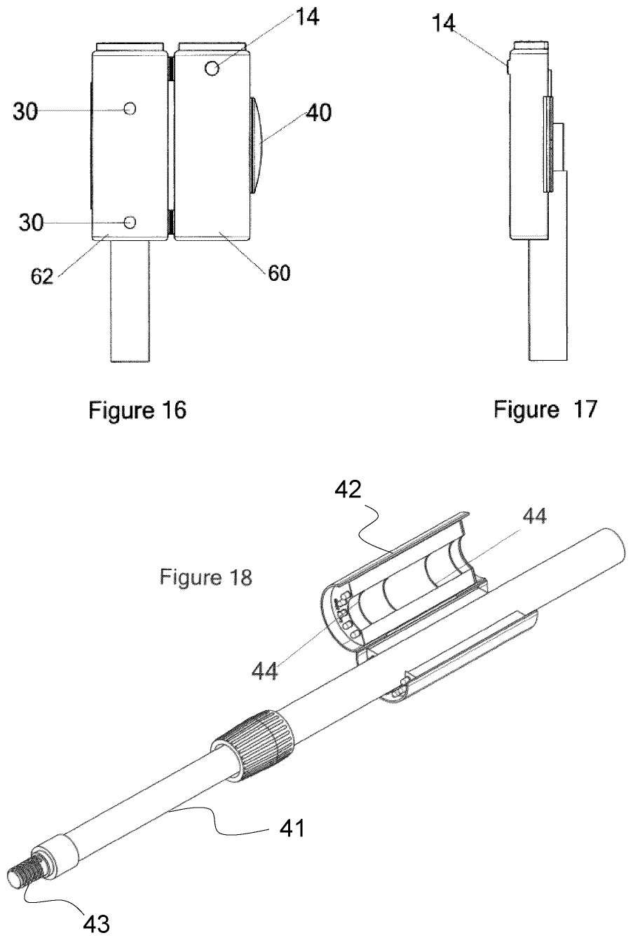

FIG. 16 is a front elevation view of the LED light in the open position showing the outer surface of the two housing sections 60 and 62 with two magnets 30 being mounted on housing section 62. FIG. 17 is a side elevation view of the LED light in the open position.

The further up the pole that the flashlight is mounted, a larger diameter of illumination is produced.

FIG. 18 is a view of a handle mounted lighting unit 42 in the opened position where non slip ribs 44 are exposed. When the light is in the closed position the non-slip ribs 44 prevent the light from sliding up or down the pole handle. These non-slip ribs 44 are made from a soft rubber or plastic material and are located internally on the upper and lower internal halves of the light. As can also be seen from the Figure is that the central passageway down the through the light 42 is off center, the upper open housing section being thicker than the housing section up against the pole. This is advantageous in that this provides more room for the battery in the battery compartment in the open housing section.

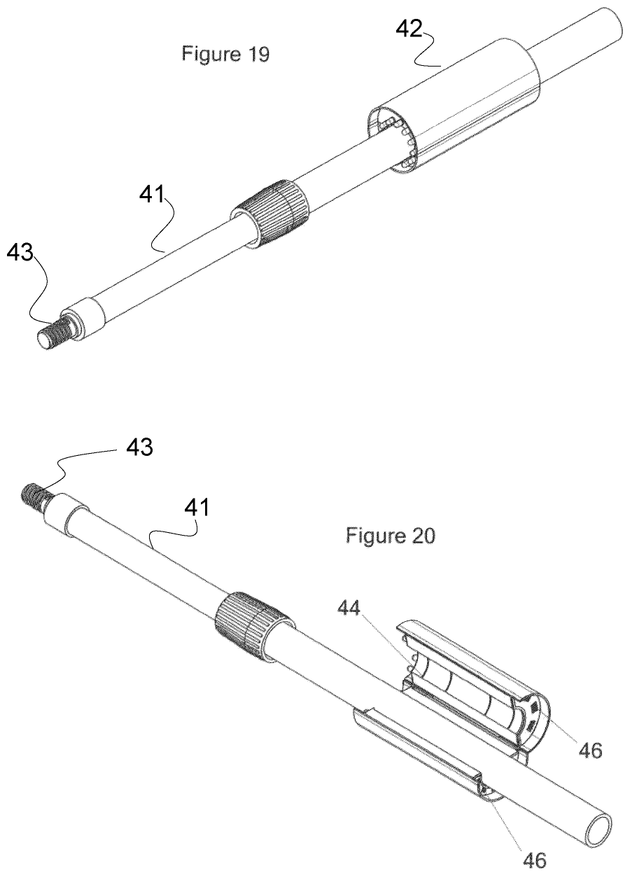

FIG. 19 is a closed view of an embodiment of the handle mounted lighting unit 42 on the extension pole 41 which is suitable to receive any number of devices on the threaded portion 43 such as paint roller frames, brooms to mention a few.

FIG. 20 is a rear view of the light unit 42 in the open position on pole 41 where a speaker 46 may be internally affixed so that sound may be streamed from a wirelessly connected device in order to listen to music or receive phone calls from any number of wireless devices such as smart phones, tablets and Pc's having wireless connectivity capabilities.

While the pole or handle has been illustrated as being cylindrical, and there being a passageway through the light unit being of circular cross section, it will be appreciated that the handle could be of any cross section and hence the light unit may be constructed with a cross section to match the cross section of the handle.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

1. A pole handle mountable flashlight, comprising:
a flashlight housing including two housing sections hingedly connected together, a passageway through said flashlight housing being formed by an inner wall of each of the two housing sections being of circular cross section to engage with a tubular shaped pole handle, a closure mechanism affixed to one of said housing sections and the other housing section being configured to be locked to said closure mechanism;
each housing section having a distal end having lights mounted therein so that when assembled on a pole handle the distal end faces toward the area tool, attached to the pole handle, is being worked, a power source mounted in at least one housing section being connected to a flashlight circuit board mounted in each housing section, said flashlight circuit board mounted in at least one housing section being connected to the lights mounted in the respective housing sections; and
an on-off switch mounted on one of the outer surfaces of one of the housing sections connected to the flashlight circuit board in each housing section.

2. The flashlight according to claim 1, wherein said housing sections both have a hemispherical shape so that when affixed to a pole handle the flashlight has a cylindrical shape.

3. The flashlight according to claim 1, wherein said housing sections are hingedly connected together by a living hinge.

4. The flashlight according to claim 1, wherein said lights are light emitting diodes (LED), and wherein said circuit board is an LED circuit board.

5. The flashlight according to claim 1, wherein said closure mechanism is a snap shut closure mechanism.

6. The flashlight according to claim 1, including foam friction pads mounted in each housing section so that when the two housing sections are closed around the pole handle friction is produced between the pole handle and flashlight to prevent rotation of the flashlight with respect to handle, and to accommodate the flashlight being fastened to different diameter pole handles.

7. The flashlight according to claim 1, including over molded friction ribs mounted in each housing section that act as a one way tube trap around the pole handle so the flashlight cannot slide up and down the handle.

8. The flashlight according to claim 1, including magnets affixed to an outer surface of one or both of said housing sections.

9. The flashlight according to claim 1, wherein said passageway through said flashlight housing is off center of a longitudinal axis of said housing so that one of said housing sections is thicker than the other housing section in which the power supply is located.

10. The flashlight according to claim 1, wherein said power source is one or more batteries.

11. The flashlight according to claim 2, wherein said housing sections are hingedly connected together by a living hinge.

12. The flashlight according to claim 2, wherein said lights are light emitting diodes (LED), and wherein said circuit board is an LED circuit board.

13. The flashlight according to claim 2, wherein said closure mechanism is a snap shut closure mechanism.

14. The flashlight according to claim 2, including foam friction pads mounted in each housing section so that when the two housing sections are closed around the pole handle friction is produced between the pole handle and flashlight to prevent rotation of the flashlight with respect to handle, and to accommodate the flashlight being fastened to different diameter pole handles.

15. The flashlight according to claim 2, including over molded friction ribs mounted in each housing section that act as a one way tube trap around the pole handle so the flashlight cannot slide up and down the handle.

16. The flashlight according to claim 2, including magnets affixed to an outer surface of one or both of said housing sections.

17. The flashlight according to claim 2, wherein said passageway through said flashlight housing is off center of a longitudinal axis of said housing so that one of said housing sections is thicker than the other housing section in which the power supply is located.

18. The flashlight according to claim 2, wherein said power source is one or more batteries.

19. The flashlight according to claim 3 wherein said closure mechanism is a snap shut closure mechanism.

20. The flashlight according to claim 3, including foam friction pads mounted in each housing section so that when the two housing sections are closed around the pole handle friction is produced between the pole handle and flashlight to prevent rotation of the flashlight with respect to handle, and to accommodate the flashlight being fastened to different diameter pole handles.
